(19) United States
(12) Patent Application Publication
(10) Pub. No.: US 2022/0377105 A1
(43) Pub. Date: Nov. 24, 2022

(54) INTELLIGENT ORCHESTRATION TO COMBAT DENIAL OF SERVICE ATTACKS

(71) Applicant: AT&T Intellectual Property I, L.P., Atlanta, GA (US)

(72) Inventors: Joseph Soryal, Glendale, NY (US); Dylan Reid, Atlanta, GA (US)

(21) Appl. No.: 17/323,719

(22) Filed: May 18, 2021

(51) Int. Cl. H04L 29/06; G06F 9/455

(52) U.S. Cl. CPC H04L 63/1458; H04L 63/1416; H04L 63/1425; H04L 63/0236; G06F 9/45558; G06F 2009/45595; G06F 2009/45587

(57) ABSTRACT

A method, system, computer readable storage medium, or apparatus provides for monitoring network traffic and creating virtual machines to inspect or block traffic when unusual network traffic is observed.

### BACKGROUND

Communication networks have migrated from using specialized networking equipment executing on dedicated hardware, like routers, firewalls, and gateways, to software defined networks (SDNs) executing as virtualized network functions (VNF) in a cloud infrastructure. To provide a service, a set of VNFs may be instantiated on general-purpose hardware. Each VNF may require one or more virtual machines (VMs) to be instantiated. In turn, VMs may require various resources, such as memory, central processing units (CPUs), and network interfaces or network interface cards (NICs). The operation and management of a large-scale cloud is highly susceptible to anomalies, attacks, and faults. Identifying the root causes is often difficult even with skilled operators.

This background information is provided to reveal information believed by the applicant to be of possible relevance. No admission is necessarily intended, nor should be construed, that any of the preceding information constitutes prior art.

### SUMMARY

A system is described for monitoring network traffic and creating virtual machines to inspect or block traffic when unusual network traffic is observed. In an example, an apparatus may include a processor and a memory coupled with the processor that effectuates operations. The operations may include monitoring communication traffic between a client device and an original virtual machine; determining a baseline communication pattern associated with at least the original virtual machine; determining that the communication traffic is outside a threshold of the baseline communication pattern; in response to the communication traffic being outside the threshold of the baseline communication pattern, providing instructions to spin up a special virtual machine, wherein the special virtual machine is a copy of the original virtual machine with an addition of a denial of service inspection module; and providing instructions to direct subsequent communication traffic from the client device to the special virtual machine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for intelligent orchestration to combat denial of service attacks.

FIG. 2 illustrates an exemplary method for intelligent orchestration to combat denial of service attacks.

FIG. 3 illustrates an exemplary method for intelligent orchestration to combat denial of service attacks

FIG. 4 illustrates a schematic of an exemplary network device.

FIG. 5 illustrates an exemplary communication system that provides wireless telecommunication services over wireless communication networks.

FIG. 6A is a representation of an exemplary network.

FIG. 6B is a representation of an exemplary hardware platform for a network.

### DETAILED DESCRIPTION

Software defined network (SDN) orchestrators may autonomously respond to demand increases (bandwidth, processor, or the like) by automatically spinning up new VMs to accommodate the spike in demand. Sometimes these demands are a result of denial of service (DoS) attacks or other malicious attacks of a network. New DoS attacks may be very sophisticated and look and feel like legitimate requests from authorized entities which may make it difficult to conventionally be detected by firewalls. Therefore, another level of security is disclosed herein. For example, there may be fake demand related to DoS attack and not bona fide service demand so an SDN orchestrator may spin up a special version of an affected virtual machine (VM) to counter the DoS attack.

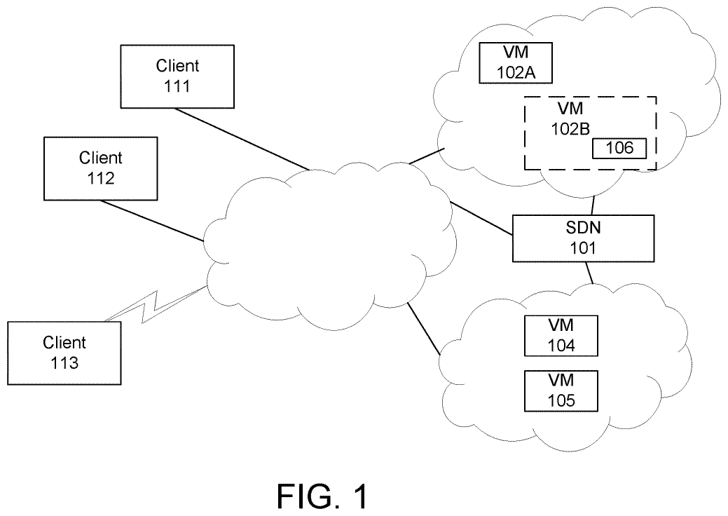

FIG. 1 illustrates an exemplary system for intelligent orchestration to combat denial of service attacks. Client 111, client 112, client 113, VM 102A, VM 102B, VM 104, VM 105, and SDN Orchestrator 101 may be wired or wireless devices that may be communicatively connected with each other. DoS inspector module (DIM) 106 may help manage communications with VMs, as disclosed in more detail herein. Client 111, client 112, or client 113, for example, may be user equipment that may connect with one or more VMs for services. SDN orchestrator 101 may manage the creation, deletion, or communication access with each VM machine.

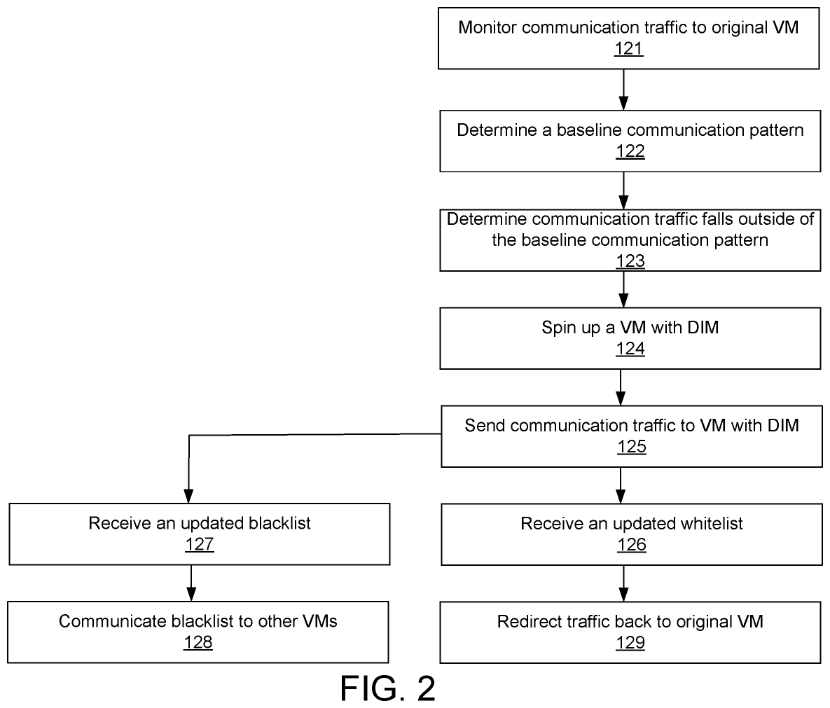

FIG. 2 illustrates an exemplary method for intelligent orchestration to combat denial of service attacks. At step 121, SDN orchestrator 101 may monitor communication traffic (e.g., data or voice communication) with VM 102A during a period. For example, client 111, client 112, or client 113 may communicate with VM 102A. The SDN orchestrator 101 may have the pattern of projected usage via time of day, day of week, special occasions (e.g., baseball game, election night), or an emergency disaster (e.g., during disaster people tend to watch the news, share certain videos, or call family members in certain areas). SDN orchestrator 101 is aware of current events and direct impact or indirect impact on new VMs demand. SDN orchestrator 101 may be aware of the demand (e.g., number of users and number of VMs to support those users), which may be different for each VM type (e.g., server, firewall, etc.).

At step 122, based on the monitoring of step 121, SDN orchestrator 10, using machine learning or the like, may determine a baseline communication pattern for communication traffic between client 111, client 112, client 113, and VM 102A.

At step 123, SDN orchestrator 101 may determine that a subset of the communication traffic (e.g., traffic from client 111) falls outside of the baseline communication pattern determined in step 122 (e.g., above threshold for typical capacity or demand).

At step 124, in response to being outside the baseline communication pattern, SDN orchestrator 101 may spin up a special VM 102B (e.g., instruct to create a special VM or activate an already created special VM) that has substantially the same functionality as original VM 102A with an additional DoS inspector module (DIM) (e.g., DoS inspection and management functionality).

At step 125, SDN orchestrator 101 may provide instructions to send the client 111 communication traffic to special VM 102B. The instructions may include all communication traffic from client 111 to VM 102A or just certain types that are part of the subset of the communication traffic. The instructions to send by SDN orchestrator 101 may be in response to a request from DIM 106 that the subset of communication route to special VM 102B (e.g., particular IP addresses, such as all new IP addresses/usernames that are not whitelisted). The DoS inspector module (DIM) may have thresholds created by using machine learning (ML). With the use of ML, the original VM code may be parsed to create a unique DoS inspector that will perform additional steps, beyond the normal VM functionality, in order to verify if the new traffic surge is DoS attack or not. DIM 106 may vary based on different factors, such as per VM type. Clients that connect to VM 102B may be required to send additional descriptive information, such as OS version, CPU make/model, RAM size/make/model, date of last updated version of operating system (OS), date of last updated version of an application, etc. This additional descriptive information may be sent in response to a request by the DIM 106 (e.g., DIM sends a message or script that is embedded in communication between VM 102B and client 111) and may be processed by DIM 106. There may be a requirement that client 111 has to execute the script to communicate with and access services of VM 102B. The additional descriptive information may serve as an “Imprint” that may help to verify the identity of the client and prevent multiple bogus sessions. Imprint may be considered a unique identifier for a machine similar to the fingerprints in humans. This functionality may have the technical effect of stopping or slowing down the potential DoS attack via constant challenges. In case client 111 is unable to execute this script, the communication may be terminated. The imprint may be sent periodically (e.g., with every message, every few messages, at particular time intervals, or the like).

At step 126, SDN orchestrator 101 may receive an updated whitelist that includes identifiers associated with the subset of communication traffic. A whitelist may include a list of network identifiers of trusted entities such as applications, network identifiers, websites, or the like that exclusively are allowed to function in the network. SDN orchestrator 101 may propagate the updated whitelist throughout the network and therefore have the subset of communication traffic allowed throughout the network.

At step 127, SDN orchestrator 101 may alternatively receive an updated blacklist that includes the subset of communication traffic. If this occurs, SDN orchestrator 101 may propagate the updated blacklist (at step 128) throughout the network and therefore have the subset of communication traffic blocked. In addition, a message (e.g., email or other alert) may be sent to the managers of client 111 to inform them of being blacklisted. A blacklist may include a list of network identifiers, applications, or executables that might pose a threat to the network, such as in the form of malware attacks or simply by hampering its state of productivity. These instructions may be received in response to an evaluation by DIM 106 using machine learning (ML) or another technique.

At step 129, SDN orchestrator 101 may receive instructions to send the subset of communication traffic from client 111 to original VM 102A. Therefore client 111 may no longer need to send imprints with its communications. Once a suspected client 111 is verified (e.g., valid requests confirmed by deep inspection to be observed following the rules and actually the requests have valid purpose (e.g., shopping, payments, etc.)), then normal communication with VM 102A can proceed.

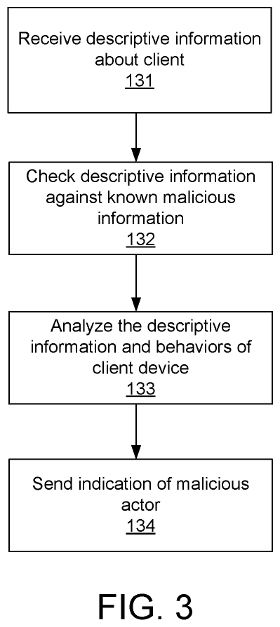

FIG. 3 illustrates an exemplary method for intelligent orchestration to combat denial of service attacks. At step 131, DIM 106 may receive descriptive information about client 111, such as IP address, usernames, telephone number (TN), operating (OS) version, central processing unit (CPU) make/model, random access memory (RAM) size/make/model, geographical information, etc. As disclosed herein, such descriptive information may be received in response to a request by DIM 106.

At step 132, check descriptive information against known malicious information. At step 133, analyze the descriptive information and behaviors of client 111. The analysis may be a comparison to baseline communication. In an example with regard to online shopping, a normal request may be an average 10-minute communication session that results (or doesn't result) in a purchase. But in a particular scenario, client 111 request is flipping through inventory quickly and the communication session last for more than 10 minutes. Such a shopping scenario could be flagged as a DoS request. Note that DIM 106 may closely monitor the packet behavior (e.g., requests or responses) once client 111 is connected with special VM 102B. At step 134, provide, by DIM 106, indications of client 111 as a malicious actor (e.g., application or client) or normal activity.

It is contemplated herein that VMs may coordinate with each other, SDN orchestrator 101, or another device in order to route suspected traffic to VM 102B with DIM 106 for filtering. DIM 106 may be created on each VM for separate inspection, on one VM 102B of a group of similarly situated VMs, or the like. Firewalls or border devices may be coordinated with to temporary or permanently block the indicated malicious client 111 or particular traffic from client 111.

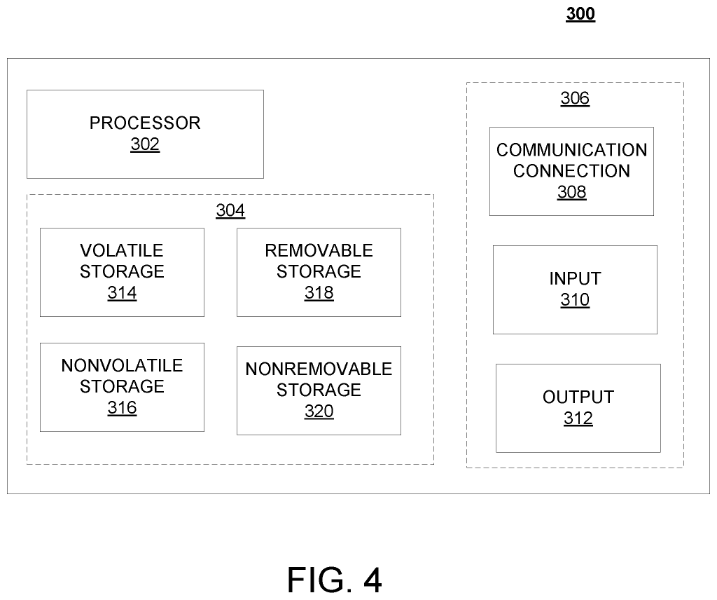

FIG. 4 is a block diagram of network device 300 that may be connected to or comprise a component of the system of FIG. 1. Network device 300 may comprise hardware or a combination of hardware and software. The functionality to facilitate telecommunications via a telecommunications network may reside in one or combination of network devices 300. Network device 300 depicted in FIG. 4 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 4 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 4) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

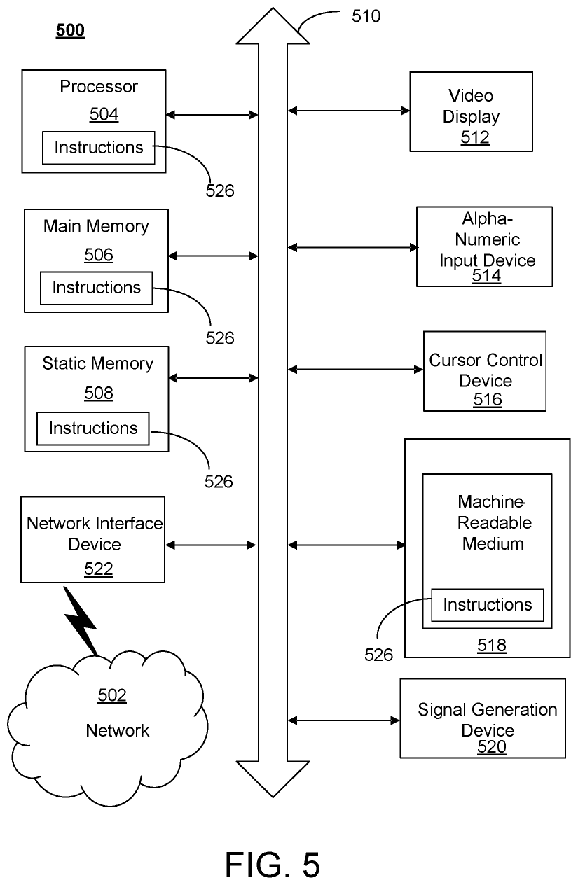

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 302 and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

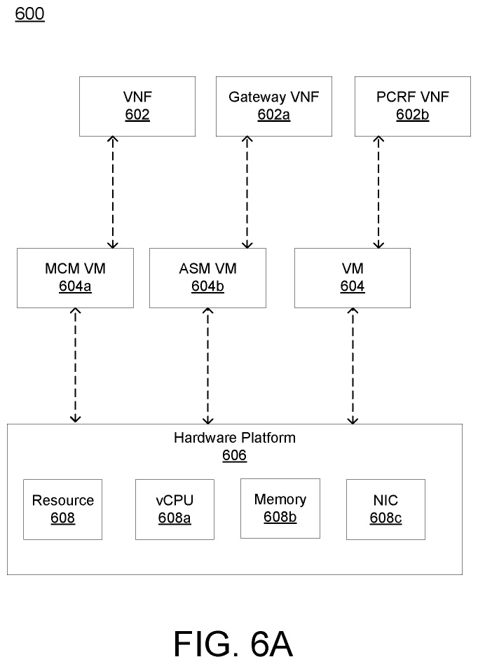

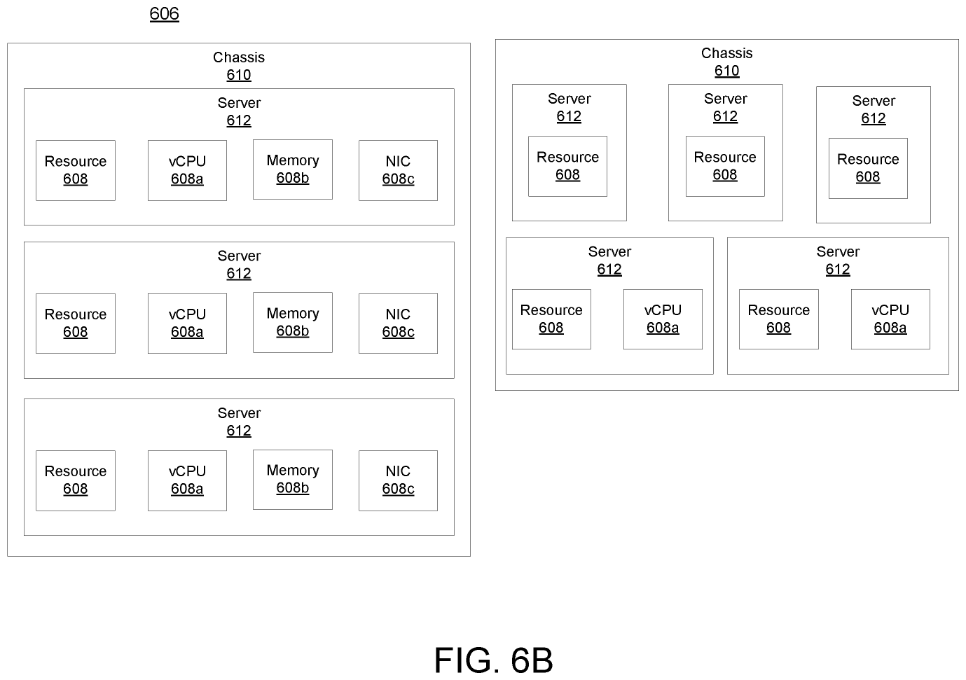

FIG. 6A is a representation of an exemplary network 600. Network 600 may include an SDN. For example, network 600 may include one or more virtualized functions implemented on general purpose hardware, such as in lieu of having dedicated hardware for every network function. That is, general purpose hardware of network 600 may be configured to run virtual network elements to support communication services, such as mobility services, including consumer services and enterprise services. These services may be provided or measured in sessions.

A virtual network functions (VNFs) 602 may be able to support a limited number of sessions. Each VNF 602 may have a VNF type that indicates its functionality or role. For example, FIG. 6A illustrates a gateway VNF 602a and a policy and charging rules function (PCRF) VNF 602b. Additionally or alternatively, VNFs 602 may include other types of VNFs. Each VNF 602 may use one or more virtual machines (VMs) 604 to operate. Each VM 604 may have a VM type that indicates its functionality or role. For example, FIG. 6A illustrates a management control module (MCM) VM 604a and an advanced services module (ASM) VM 604b. Additionally or alternatively, VMs 604 may include other types of VMs, such as a DEP VM (not shown). Each VM 604 may consume various network resources from a hardware platform 606, such as a resource 608, a virtual central processing unit (vCPU) 608a, memory 608b, or a network interface card (NIC) 608c. Additionally or alternatively, hardware platform 606 may include other types of resources 608.

While FIG. 6A illustrates resources 608 as collectively contained in hardware platform 606, the configuration of hardware platform 606 may isolate, for example, certain memory 608c from other memory 608c. FIG. 6B provides an exemplary implementation of hardware platform 606.

Hardware platform 606 may comprise one or more chassis 610. Chassis 610 may refer to the physical housing or platform for multiple servers or other network equipment. In an aspect, chassis 610 may also refer to the underlying network equipment. Chassis 610 may include one or more servers 612. Server 612 may comprise general purpose computer hardware or a computer. In an aspect, chassis 610 may comprise a metal rack, and servers 612 of chassis 610 may comprise blade servers that are physically mounted in or on chassis 610.

Each server 612 may include one or more network resources 608, as illustrated. Servers 612 may be communicatively coupled together (not shown) in any combination or arrangement. For example, all servers 612 within a given chassis 610 may be communicatively coupled. As another example, servers 612 in different chassis 610 may be communicatively coupled. Additionally or alternatively, chassis 610 may be communicatively coupled together (not shown) in any combination or arrangement.

The characteristics of each chassis 610 and each server 612 may differ. For example, FIG. 6B illustrates that the number of servers 612 within two chassis 610 may vary. Additionally or alternatively, the type or number of resources 610 within each server 612 may vary. In an aspect, chassis 610 may be used to group servers 612 with the same resource characteristics. In another aspect, servers 612 within the same chassis 610 may have different resource characteristics.

Given hardware platform 606, the number of sessions that may be instantiated may vary depending upon how efficiently resources 608 are assigned to different VMs 604. For example, assignment of VMs 604 to particular resources 608 may be constrained by one or more rules. For example, a first rule may require that resources 608 assigned to a particular VM 604 be on the same server 612 or set of servers 612. For example, if VM 604 uses eight vCPUs 608a, 1 GB of memory 608b, and 2 NICs 608c, the rules may require that all of these resources 608 be sourced from the same server 612. Additionally or alternatively, VM 604 may require splitting resources 608 among multiple servers 612, but such splitting may need to conform with certain restrictions. For example, resources 608 for VM 604 may be able to be split between two servers 612. Default rules may apply. For example, a default rule may require that all resources 608 for a given VM 604 must come from the same server 612.

An affinity rule may restrict assignment of resources 608 for a particular VM 604 (or a particular type of VM 604). For example, an affinity rule may require that certain VMs 604 be instantiated on (that is, consume resources from) the same server 612 or chassis 610. For example, if VNF 602 uses six MCM VMs 604a, an affinity rule may dictate that those six MCM VMs 604a be instantiated on the same server 612 (or chassis 610). As another example, if VNF 602 uses MCM VMs 604a, ASM VMs 604b, and a third type of VMs 604, an affinity rule may dictate that at least the MCM VMs 604a and the ASM VMs 604b be instantiated on the same server 612 (or chassis 610). Affinity rules may restrict assignment of resources 608 based on the identity or type of resource 608, VNF 602, VM 604, chassis 610, server 612, or any combination thereof.

An anti-affinity rule may restrict assignment of resources 608 for a particular VM 604 (or a particular type of VM 604). In contrast to an affinity rule—which may require that certain VMs 604 be instantiated on the same server 612 or chassis 610—an anti-affinity rule requires that certain VMs 604 be instantiated on different servers 612 (or different chassis 610). For example, an anti-affinity rule may require that MCM VM 604a be instantiated on a particular server 612 that does not contain any ASM VMs 604b. As another example, an anti-affinity rule may require that MCM VMs 604a for a first VNF 602 be instantiated on a different server 612 (or chassis 610) than MCM VMs 604a for a second VNF 602. Anti-affinity rules may restrict assignment of resources 608 based on the identity or type of resource 608, VNF 602, VM 604, chassis 610, server 612, or any combination thereof.

Within these constraints, resources 608 of hardware platform 606 may be assigned to be used to instantiate VMs 604, which in turn may be used to instantiate VNFs 602, which in turn may be used to establish sessions. The different combinations for how such resources 608 may be assigned may vary in complexity and efficiency. For example, different assignments may have different limits of the number of sessions that can be established given a particular hardware platform 606.

For example, consider a session that may require gateway VNF 602a and PCRF VNF 602b. Gateway VNF 602a may require five VMs 604 instantiated on the same server 612, and PCRF VNF 602b may require two VMs 604 instantiated on the same server 612. (Assume, for this example, that no affinity or anti-affinity rules restrict whether VMs 604 for PCRF VNF 602b may or must be instantiated on the same or different server 612 than VMs 604 for gateway VNF 602a.) In this example, each of two servers 612 may have enough resources 608 to support 10 VMs 604. To implement sessions using these two servers 612, first server 612 may be instantiated with 10 VMs 604 to support two instantiations of gateway VNF 602a, and second server 612 may be instantiated with 9 VMs: five VMs 604 to support one instantiation of gateway VNF 602a and four VMs 604 to support two instantiations of PCRF VNF 602b. This may leave the remaining resources 608 that could have supported the tenth VM 604 on second server 612 unused (and unusable for an instantiation of either a gateway VNF 602a or a PCRF VNF 602b). Alternatively, first server 612 may be instantiated with 10 VMs 604 for two instantiations of gateway VNF 602a and second server 612 may be instantiated with 10 VMs 604 for five instantiations of PCRF VNF 602b, using all available resources 608 to maximize the number of VMs 604 instantiated.

Consider, further, how many sessions each gateway VNF 602a and each PCRF VNF 602b may support. This may factor into which assignment of resources 608 is more efficient. For example, consider if each gateway VNF 602a supports two million sessions, and if each PCRF VNF 602b supports three million sessions. For the first configuration—three total gateway VNFs 602a (which satisfy the gateway requirement for six million sessions) and two total PCRF VNFs 602b (which satisfy the PCRF requirement for six million sessions)—would support a total of six million sessions. For the second configuration—two total gateway VNFs 602a (which satisfy the gateway requirement for four million sessions) and five total PCRF VNFs 602b (which satisfy the PCRF requirement for 15 million sessions)—would support a total of four million sessions. Thus, while the first configuration may seem less efficient looking only at the number of available resources 608 used (as resources 608 for the tenth possible VM 604 are unused), the second configuration is actually more efficient from the perspective of being the configuration that can support more the greater number of sessions.

To solve the problem of determining a capacity (or, number of sessions) that can be supported by a given hardware platform 605, a given requirement for VNFs 602 to support a session, a capacity for the number of sessions each VNF 602 (e.g., of a certain type) can support, a given requirement for VMs 604 for each VNF 602 (e.g., of a certain type), a give requirement for resources 608 to support each VM 604 (e.g., of a certain type), rules dictating the assignment of resources 608 to one or more VMs 604 (e.g., affinity and anti-affinity rules), the chassis 610 and servers 612 of hardware platform 606, and the individual resources 608 of each chassis 610 or server 612 (e.g., of a certain type), an integer programming problem may be formulated.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—intelligent orchestration to combat denial of service attacks—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for intelligent orchestration to combat denial of service attacks. A method, system, computer readable storage medium, or apparatus provides for monitoring communication traffic between a client device and an original virtual machine; determining a baseline communication pattern with at least the original virtual machine; determining that the communication traffic is outside a threshold of the baseline communication pattern; in response to the communication traffic being outside the threshold of the baseline communication pattern, providing instructions to spin up a special virtual machine, wherein the special virtual machine is a copy of the original virtual machine with an addition of a denial of service inspection module; and providing instructions to direct subsequent communication traffic from the client device to the special virtual machine. The subsequent communication traffic is directed based on a username associated with the subsequent communication traffic. The denial of service inspection module determines whether the subsequent communication traffic is malicious. The denial of service inspection module determines whether the subsequent communication traffic is a denial of service attack. The denial of service inspection module periodically requests descriptive information from the client device, wherein the descriptive information may include operating system version, central processing unit (CPU) make, or CPU model. The descriptive information may include random access memory (RAM) size, RAM make, or RAM model. The method, system, computer readable storage medium, or apparatus may provide for receiving an updated whitelist that includes identifiers associated with the subset of communication traffic. A method, system, computer readable storage medium, or apparatus provides for monitoring communication traffic to an original virtual machine; obtaining a baseline communication pattern associated with at least the original virtual machine; determining that the communication traffic is outside a threshold of the baseline communication pattern; in response to the communication traffic being outside the threshold of the baseline communication pattern, providing instructions to spin up a special virtual machine, wherein the special virtual machine is a copy of the original virtual machine with an addition of a denial of service inspection module; and providing instructions to direct subsequent communication traffic from the client device to the special virtual machine. All combinations in this paragraph (including the removal or addition of steps) are contemplated in a manner that is consistent with the other portions of the detailed description.

What is claimed:

1. A method comprising:
monitoring communication traffic between a client device and an original virtual machine;
determining a baseline communication pattern with at least the original virtual machine;
determining that the communication traffic is outside a threshold of the baseline communication pattern;
in response to the communication traffic being outside the threshold of the baseline communication pattern, providing instructions to spin up a special virtual machine, wherein the special virtual machine is a copy of the original virtual machine with an addition of a denial of service inspection module; and
providing instructions to direct subsequent communication traffic from the client device to the special virtual machine.

2. The method of claim 1, wherein the subsequent communication traffic is directed based on a username associated with the subsequent communication traffic.

3. The method of claim 1, wherein the denial of service inspection module determines whether the subsequent communication traffic is malicious.

4. The method of claim 1, wherein the denial of service inspection module determines whether the subsequent communication traffic is a denial of service attack.

5. The method of claim 1, wherein the denial of service inspection module periodically requests descriptive information from the client device, wherein the descriptive information comprises operating system version, central processing unit (CPU) make, or CPU model.

6. The method of claim 1, wherein the denial of service inspection module periodically requests descriptive information from the client device, wherein the descriptive information comprises random access memory (RAM) size, RAM make, or RAM model.

7. The method of claim 1, further comprising receiving, from the denial of service inspection module, an updated whitelist that includes identifiers associated with a subset of the communication traffic.

8. A system comprising:
one or more processors; and
memory coupled with the one or more processors, the memory storing executable instructions that when executed by the one or more processors cause the one or more processors to effectuate operations comprising:
monitoring communication traffic between a client device and an original virtual machine;
determining a baseline communication pattern with at least the original virtual machine;
determining that communication traffic is outside a threshold of the baseline communication pattern;
in response to the communication traffic being outside the threshold of the baseline communication pattern, providing instructions to spin up a special virtual machine, wherein the special virtual machine is a copy of the original virtual machine with an addition of a denial of service inspection module; and
providing instructions to direct subsequent communication traffic from the client device to the special virtual machine.

9. The system of claim 8, wherein the subsequent communication traffic is directed based on a username associated with the subsequent communication traffic.

10. The system of claim 8, wherein the denial of service inspection module determines whether the subsequent communication traffic is malicious.

11. The system of claim 8, wherein the denial of service inspection module determines whether the subsequent communication traffic is a denial of service attack.

12. The system of claim 8, wherein the denial of service inspection module periodically requests descriptive information from the client device, wherein the descriptive information comprises operating system version, central processing unit (CPU) make, or CPU model.

13. The system of claim 8, wherein the denial of service inspection module periodically requests descriptive information from the client device, wherein the descriptive information comprises random access memory (RAM) size, RAM make, or RAM model.

14. The system of claim 8, the operations further comprising receiving, from the denial of service inspection module, an updated whitelist that includes identifiers associated with a subset of the communication traffic.

15. A computer readable storage medium storing computer executable instructions that when executed by a computing device cause said computing device to effectuate operations comprising:
monitoring communication traffic between a client device and an original virtual machine;
determining a baseline communication pattern with at least the original virtual machine;
determining that the communication traffic is outside a threshold of the baseline communication pattern;
in response to the communication traffic being outside the threshold of the baseline communication pattern, providing instructions to spin up a special virtual machine, wherein the special virtual machine is a copy of the original virtual machine with an addition of a denial of service inspection module; and
providing instructions to direct subsequent communication traffic from the client device to the special virtual machine.

16. The computer readable storage medium of claim 15, wherein the subsequent communication traffic is directed based on a username associated with the subsequent communication traffic.

17. The computer readable storage medium of claim 15, wherein the denial of service inspection module determines whether the subsequent communication traffic is malicious.

18. The computer readable storage medium of claim 15, wherein the denial of service inspection module determines whether the subsequent communication traffic is a denial of service attack.

19. The computer readable storage medium of claim 15, wherein the denial of service inspection module periodically requests descriptive information from the client device, wherein the descriptive information comprises operating system version, central processing unit (CPU) make, or CPU model.

20. The computer readable storage medium of claim 15, wherein the denial of service inspection module periodically requests descriptive information from the client device, wherein the descriptive information comprises random access memory (RAM) size, RAM make, or RAM model.
